(19) United States
(12) Patent Application Publication
(10) Pub. No.: US 2017/0082998 A1
(43) Pub. Date: Mar. 23, 2017

(54) MONITORING OF FAILURE TOLERANCE FOR AN AUTOMATION INSTALLATION

(71) Applicant: SIEMENS AKTIENGESELLSCHAFT, 80333 München (DE)

(72) Inventors: THOMAS GROSCH, Rosstal (DE); JAN RICHTER, Lauf an der Pegnitz (DE)

(73) Assignee: SIEMENS AKTIENGESELLSCHAFT, 80333 München (DE)

(21) Appl. No.: 15/305,937

(22) PCT Filed: Apr. 22, 2014
(86) PCT No.: PCT/EP2014/058115

§ 371 Date: Oct. 21, 2016

(51) Int. Cl. G05B 19/05

(52) U.S. Cl. CPC G05B 19/058; G05B 2219/14036

(57) ABSTRACT

A method for monitoring failure tolerance for an automation installation is disclosed. The automation installation operates a process via a controlled system. At least two control apparatuses alternately regulate the controlled system in a control mode by outputting control outputs and failure of the currently regulating control apparatus prompts changeover to another of the control apparatuses. During the changeover, the controlled system continues to be operated in controller-less fashion for a down time. At least one operating point for the controlled system that is possible in control mode is ascertained. Controller-less operation is respectively simulated for each operating point for the duration of the down time. A state trajectory setting out from the operating point is ascertained for the controlled system and a check is performed to determine whether the state trajectory fails to meet a predetermined safety criterion. A predetermined protective measure is initiated to avoid the operating point.

The invention relates to a method for monitoring a failure tolerance for an automation installation. The automation installation is used to operate or perform a process, for example generating electric power from nuclear power, by means of a controlled system. The automation installation is meant to be failure safe and, to this end, has at least two control apparatuses that alternately control the controlled system. In the event of failure of the currently controlling control apparatus, the arrangement changes over to another control apparatus. In this context, there must be the assurance that the process can continue to be operated safely during changeover.

The described high-availability solution of installation control by means of at least two control apparatuses reduces any standstill periods that arise for the automation installation to a minimum. The development of high-availability solutions of this kind is currently very cost intensive, however. The primary accomplishment of such an automation system is automatic failover, that is to say changeover, in the event of failure of one of the control apparatuses, for example as a result of CPU failure (CPU—central processing unit). Control of the process can then be continued on a backup CPU. This failover is never totally without repercussions for the process. Usually, what is demanded is smooth failover, that is to say that the output of the control apparatuses, that is to say the inputs of the controlled system of the process, must have no discernible jumps that are caused not by an alteration in the controlled system but rather exclusively on account of failure of the control apparatus. The outputs must thus behave constantly, so that the control signal for the controlled system, that is to say the sequence of control outputs, must not fluctuate beyond a predetermined measure due to failure.

Usually, a limited period of time is tolerated in which the control outputs transmitted to the controlled system retain their last value before control of the controlled system is then continued by the backup CPU. Influencing factors for the down time that is to be expected, during which the constant control output is output, are the failover response of the control apparatuses and the failover response of the controlled system. Depending on the peripheral components used that are actuated by the control apparatuses and monitor and control the process, one of the two influencing factors is normally dominant.

Today, the user of an automation installation himself has to judge whether the process to be controlled can tolerate the effects of a failover. A failover must not result in destabilization of the process. Nowadays, the user answers these questions on the basis of empirical values about his process or empirical values about similar processes.

The invention is based on the object of checking the failover response of an automation installation to determine whether the automation installation has sufficient failure tolerance toward failure of one of its control apparatuses.

The invention achieves the object by means of the subjects of the independent patent claims. Advantageous developments of the invention are obtained by means of the features of the dependent patent claims.

The method according to the invention sets out from the automation installation described at the outset, in which a controlled system is used to perform a process, that is to say, by way of example, that electric power is generated from nuclear power, bottles are filled, crude oil is refined or a building is heated. The automation installation has at least two control apparatuses provided that alternately control the controlled system during normal operation, which comprises output of control outputs. In this context, alternately means that failure of the currently controlling control apparatus prompts changeover to another of the control apparatuses. During changeover, the controlled system continues to be operated in controller-less fashion, the changeover requiring a period of time that is referred to in this case as a down time. The control apparatuses may each be a programmable logic controller (PLC), for example.

The automation installation is now monitored by the method to determine whether it is failure tolerant. In other words, a check is performed to determine whether failure of one control apparatus and changeover to another control apparatus is possible without this involving the process reaching a predetermined, undesirable critical state, that is to say the controlled system adopting an undesirable operating state, within the down time.

On the basis of the method according to the invention, this is accomplished by virtue of at least one operating point that is possible for the controlled system during normal operation being ascertained. In this context, an operating point describes a possible operating state of the controlled system and can be represented or described as a vector of operating variables, for example. Such an operating variable may be a temperature, a rotational speed or a conveying speed in each case, for example. These operating variables each describe a state of at least one peripheral component, that is to say of a sensor or an actuator, for example, of the automation installation. Overall, the operating point, i.e. the operating state of the whole controlled system, is then obtained from all of the operating variables.

For each operating point, a respective check is now performed to determine whether, on the basis of this operating point, it is possible to change over between the control apparatuses and, in this context, controller-less operation is possible safely for the down time. This is accomplished by simulating respective controller-less operation for each operating point for the duration of the down time and thereby ascertaining a state trajectory for the controlled system that starts out from the operating point. The state trajectory is thus compiled from a temporal sequence of operating points that are obtained from the changeover time onward during controller-less operation in accordance with the simulation. The respective state trajectory has a check performed for it to determine whether it fails to meet a predetermined safety criterion. If need be, a predetermined protective measure is initiated to avoid this operating state from which changeover has led to the critical state trajectory.

In connection with the invention, the term controlled system covers the at least one peripheral component that is provided for controlling the process in the automation installation, that is to say the sensors and actuators of the automation installation, the communication network that couples the control apparatuses to the at least one peripheral component, and the process itself, that is to say the installation components monitored and/or controlled by the peripheral components, such as conveyor belts, gantries or pipes, for example.

The invention has the advantage that a method is now provided that assists in estimating the effects of a changeover action on the process and thus reduces the risk of misjudgment of an operation of the automation installation. This allows the user of the automation installation to be assisted in selecting the automation solution that is right for him.

In this connection, the invention also provides an engineering system for designing and/or configuring an automation installation. The engineering system can be used to check an automation installation having at least two control apparatuses for controlling a controlled system. According to the invention, the engineering system has an analysis device, for example a processor device, such as a computer, for example. The analysis device is designed to take a present topology model of the automation installation and a process model as a basis for ascertaining the resultant controlled system. In this context, the topology model describes the peripheral components that are in place, which are referred to as a whole as quantities, and the linking thereof via, by way of example, a communication network and their mechanical connection and the monitored and/or controlled installation components, such as conveyor belts or boilers, for example. A process model describes the process to be performed by means of the automation installation, i.e. the physical actions that take place during performance of the process, Methods for providing process models for a prescribed process are numerous in the prior art.

The analysis device is furthermore designed to ascertain a down time caused by a changeover between the control apparatuses, that is to say the changeover period, and, on the basis of an embodiment of the method according to the invention, to check or to monitor whether the automation installation is failure tolerant. The engineering system according to the invention has the advantage that a deficiency in the failure tolerance can be identified as early as during the design of an automation installation and can be rectified by the described protective measures,

Finally, the invention also includes an automation installation having a controlled system for performing a process and having at least two control apparatuses for failsafe, alternate control of the controlled system. In this context, failsafe means the described changeover action in the event of failure of one of the controlled apparatuses. The automation installation according to the invention is designed to monitor its failure tolerance during operation by performing an embodiment of the method according to the invention. In the case of the automation installation according to the invention, the advantage arises that said automation installation identifies, even during operation, that a critical operating point may be present that needs to be avoided by taking a protective measure.

The text below describes advantageous developments of the method according to the invention that are also corresponding developments of the engineering system according to the invention and of the automation installation according to the invention.

According to one embodiment of the invention, simulation of controller-less operation starting out from the respective possible operating point by means of a model of the controlled system involves temporally successive operating points being computed. The computed operating points are then combined to produce the state trajectory. This embodiment uses a model of the controlled system in order to ascertain the effects of a changeover action. In control-engineering applications today, that is to say process engineering, the control system, as provided by any control apparatus, often comprises a model of the controlled system. By way of example, this is therefore necessary because state variables of the controlled system frequently cannot be measured directly or can be measured only with an undesirably high level of complexity, and are therefore estimated. This can be accomplished by using what is known as an observer, such as a Luenberger observer, for example. Such an observer or, generally, the model of the controlled system of a control system can also be used advantageously for the simulation. This embodiment has the advantage that models of a controlled system that are already in place are used and, in this context, the simulation and the actual control of the controlled system are based on the same model, which improves the reliability of the simulation result. The simulation itself can be performed by solving a differential equation that describes a dynamic response of the controlled system, for example.

The described safety criterion comprises particularly a check being performed to determine whether the state trajectory comprises at least one operating point that is situated outside a predetermined admissible operating range. This operating range can be ascertained in a manner that is known to a person skilled in the art by operating limits of the peripheral components of the controlled system.

Additionally or alternatively, there may be provision for the safety criterion checked to be whether a dynamic transition between two operating points of the state trajectory is greater than a predetermined maximum admissible dynamic range. By way of example, it is thus possible to ascertain a period of time within which the state trajectory transitions from a predetermined first operating point to a second predetermined operating point. If this period of time is too short, then this can mean that a peripheral component of the controlled system or an installation component is overloaded, for example mechanically or thermally, although this component would absolutely tolerate the transition if the dynamic range of the transition were smaller.

With reference to the initiated protective measures, multiple different embodiments of the invention are likewise obtained.

One development assumes that during controller-less operation, that is to say during changeover, a constant control output is transmitted to the controlled system, as has been described at the outset. In this case, the protective measure can comprise a constant control output being ascertained that still reveals, for the ascertained critical operating point, a safe state trajectory for continued operation of the controlled system after all. The ascertained constant control output is then assigned to the operating point, which means that in the event of failure of the control apparatus while the controlled system is at the operating point, the ascertained constant control output is output to the controlled system during changeover. This results in the advantage that there is an already checked constant control output for all critical operating points as a result of the assignment, so that it is possible to resort to this control output, that is to say to a vector with control values for the individual peripheral components, for example, and safe changeover is therefore ensured for this critical operating point too.

Another development provides for a critical operating point to be assigned a safety control output that is output at the operating point in the event of a changeover and, as a result, interrupts an operation of the controlled system. In other words, an emergency stop for the controlled system is initiated in the event of failure of the control apparatus while the controlled system is at this operating point.

According to another embodiment, the protective measure comprises engineering data from the automation installation, that is to say data relating to the installation topology or the programming of the components, being taken as a basis for ascertaining that installation component that causes the greatest proportion of the down time. Besides the control apparatuses, this can also involve, by way of example, the communication network that couples the control apparatuses to peripheral components, and/or individual peripheral components that require a relatively long period of time to acknowledge control commands, for example, being checked. In other words, according to this embodiment, a bottleneck in the automation installation is ascertained that slows down changeover. Overall, this is accomplished by analyzing the communication network and/or the quantities. By changing the engineering of the automation installation, it is then possible to decrease the down time. In addition or as an alternative to this analysis of the components that cause the down time, there may be provision for ascertaining that installation component that adopts an inadmissible state, so that the state trajectory fails to meet the safety criterion. Thus, by way of example, that installation component that becomes too hot or is mechanically overloaded or moves too quickly is ascertained. The user can then adjust this installation component in a specific manner by altering the engineering data or by replacing the installation component, and can thereby increase failure tolerance.

Another development provides for the control apparatuses to use a synchronization connection to interchange synchronization data with one another for aligning controller states. In the event of failure of one of the control apparatuses, this allows the other control apparatus to immediately continue normal operation at the point at which the failed control apparatus stopped. In this case, the protective measure comprises a rate of the synchronization actions, that is to say the frequency with which the synchronization data are interchanged within a prescribed period, being increased. This advantageously increases the likelihood of the control apparatuses being in sync at the moment of failure. In addition, the control apparatus taking over requires less time to adjust its controller system to suit the present control situation.

According to another development, the protective measure comprises the respective operating point that resulted in the trajectory that fails to meet the safety criterion being excluded from normal operation. In other words, the controlled system thus never adopts this critical operating point. In order to exclude the operating point, the control parameters of the control apparatus are preferably adjusted, so that the operating limits are narrowed down accordingly.

With reference to the simulation, an advantageous development is obtained when an assumption about a maximum absolute value of a disturbance variable acting in the controlled system is used, e.g. a coefficient of friction or a coefficient of sliding friction, in which case the protective measure comprises the maximum absolute value being decreased and the simulation being performed afresh. If the result in this case is then that the safety criterion is now met for the decreased disturbance variable, then this disturbance variable is indicated, for example by means of a display on a display device, so that the user of the automation installation can decrease this disturbance variable in a specific manner by means of constructive measures. In other words, that disturbance variable that would lead to the unsafe or critical operating state if one of the control apparatuses were to fail at the examined operating point is thus detected.

In order to increase failure tolerance still further, one embodiment provides for performance of the protective measures to be followed by the monitoring of the failure tolerance being performed afresh, so that the failure tolerance thus increases iteratively with every further protective measure initiated.

The method requires stipulation of the initial operating points for which the simulation is performed. According to one embodiment of the invention, this is stipulated by using a configuration of the automation installation to ascertain an expected or intended operating range. Thus, configuration parameters are used to ascertain what operating points could theoretically arise during correct operation.

Alternatively, there may be provision for the automation installation to be observed during operation and for this to ascertain the most likely operating points during normal operation. This results in the particular advantage that protective measures are ascertained for the most likely operating points.

Another opportunity to use the fewest checking steps possible to improve the automation installation in terms of its failure tolerance is achieved according to one embodiment of the method by virtue of the at least one possible operating point being ascertained by taking into consideration only extreme values of the manipulated variable restrictions of installation components, that is to say, by way of example, that a particular valve, which is a peripheral component, is checked only in the maximum open position and the closed position.

An exemplary embodiment of the invention is described below. In this regard:

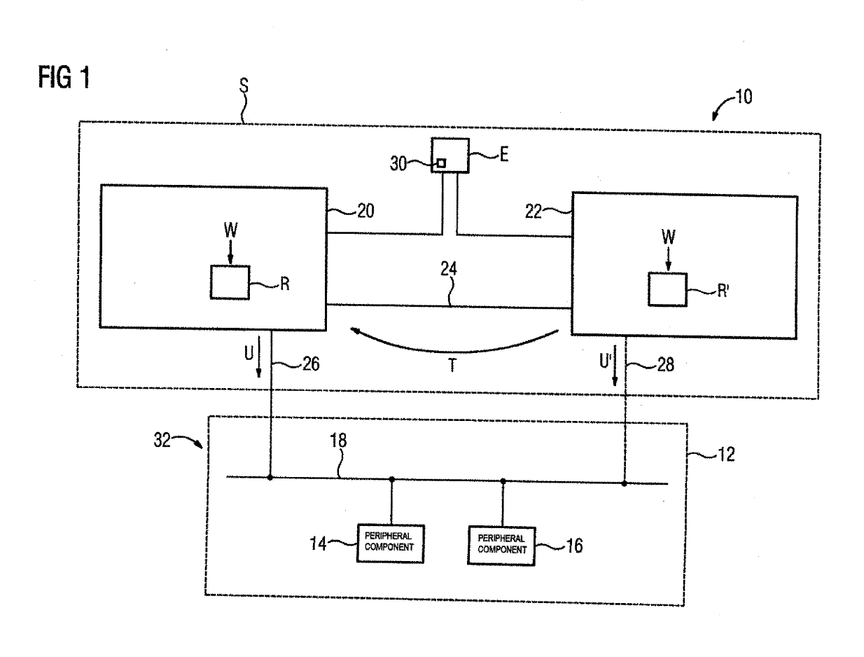

FIG. 1 shows a schematic representation of an embodiment of the automation installation according to the invention and of the engineering system according to the invention,

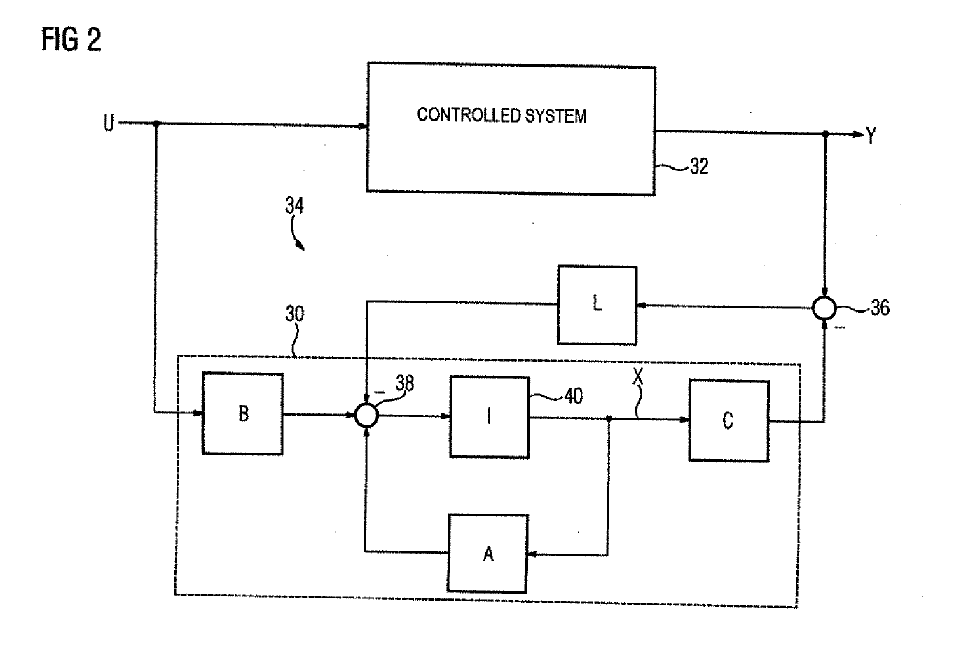

FIG. 2 shows a flow diagram of a control system, as may be part of control apparatuses of the automation installation from FIG. 1,

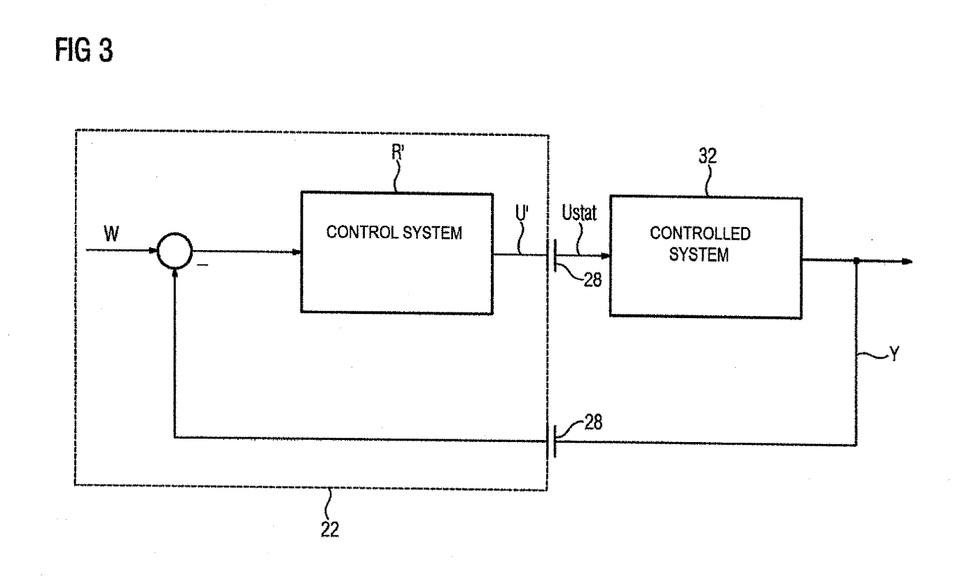

FIG. 3 shows a signal flow diagram for the automation installation from FIG. 1 during a changeover between control apparatuses, and

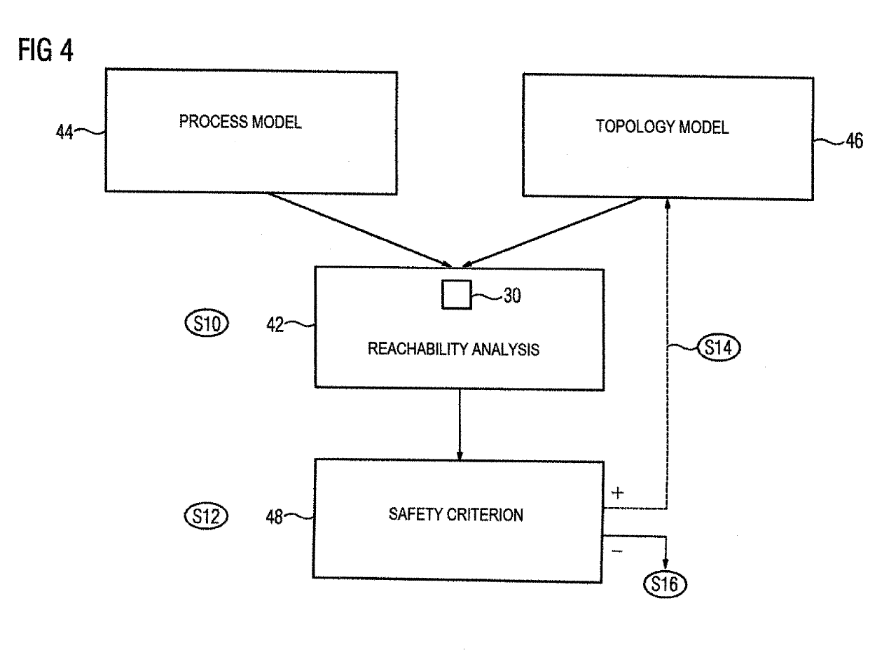

FIG. 4 shows an outline to illustrate an embodiment of the method according to the invention, as can be performed for the engineering system and the automation installation from FIG. 1.

The exemplary embodiment explained below is a preferred embodiment of the invention. In the case of the exemplary embodiment, however, the described components of the embodiment are each individual features of the invention that are intended to be considered independently of one another and that each also develop the invention independently of one another and hence can also be regarded as part of the invention individually or in a combination other than that shown. Furthermore, the described embodiment is also augmentable by further instances of the features of the invention that have already been described.

FIG. 1 shows an automation installation 10 for the automated operational performance of a process, such as generating electric power from nuclear power, filling bottles, refining or heating, for example. The automation installation 10 comprises an automation system S by means of which the process 12 is controlled. For the purpose of monitoring and influencing the process 12, there may be peripheral components 14, 16 and further peripheral components (not shown) provided. A peripheral component can comprise a sensor and/or an actuator. By way of example, the peripheral component 14 may be a sensor, such as a temperature sensor or a light barrier, for example. By way of example, the peripheral component 16 may be an actuator or a control element, such as an electric motor or a controllable valve, for example. The automation system S may be coupled to the peripheral components 14, 16 via a communication network 18. The communication network 18 can comprise a Profibus, for example.

By way of example, the automation system S can comprise two control apparatuses 20, 22 that may each have a PLC, for example. There may also be further control apparatuses (not shown) provided. Each control apparatus 20, 22 may be designed to use a control system R, R′ to regulate the controlled system 32 to a nominal value preset W. In this case, the control apparatuses 20, 22 control the controlled system 32 not simultaneously but rather alternately, a change being able to take place whenever the currently controlling control apparatus 20, 22 fails.

FIG. 1 shows the situation in which the control apparatus 22 has failed and therefore the control apparatus 20 uses its control system R to output control outputs U to the peripheral components 14, 16 via a control system link 26 in order to regulate the controlled system 32 to the nominal value preset W. A controlled system link 28 of the failed control apparatus 22 is broken or decoupled, so that any erroneous control outputs U′ by the control system R′ of the control apparatus 22 have no influence on the controlled system 32.

The automation system S has a high level of availability as a result of the redundant design with at least two control apparatuses 20, 22. The peripheral components 14, 16 connected to the automation system S can be controlled by both control apparatuses 20, 22 in principle. So that both control apparatuses 20, 22 can operate in sync, they can be synchronized via a synchronization connection 24 at prescribed intervals of time. The synchronization connection 24 may be a direct connection (as represented in FIG. 1) or may be implemented via the communication network 18, for example. In terms of the frequency of the synchronization and the scope thereof, different forms can be preset. In order to explicitly identify the erroneous control apparatus for the changeover in the event of an error, there is provision for a system diagnosis, which is known per se from the prior art.

The changeover action has lasted for a down time T during which neither the control apparatus 20 nor the control apparatus 22 have output their control outputs U, to the control system 32. During this time, a steady control output Ustat has been output to the peripheral components 14, 16. By way of example, this can be achieved by virtue of the communication network 18 involving timeslot-based communication and the values transmitted for the individual timeslots not being erased, so that they continue to be output to the peripheral components 14, 16 even when the communication cycle is repeated.

The control apparatuses 20, 22 can be configured by an engineering system E in the automation installation 10. The engineering system E can also be used to plan a topology of the automation system 10, as is needed in order to operate the process 12 in a desired manner.

The automation installation 10 has the assurance that one of the control apparatuses 20, 22 can fail at any time and the control system 32 can then continue to be operated, that is to say that the flow of the process 12 can be maintained without the process 12 reaching an undesirable state, that is to say that an operating point of the controlled system 32 is situated outside a predetermined set of admissible operating points, during the down time T.

The two controller systems R, R′ can involve a controller algorithm that is known per se, for example a proportional controller, integral controller, differential controller or a hybrid form thereof, such as a PID controller, for example. The control systems R, R′ can particularly also comprise an observer, as is represented by way of example in FIG. 2. The observer 34 can be used to ascertain operating points of the controlled system 32. The operating parameter values provided at the particular time, which together define the operating point, can be combined to produce a vector that describes the operating state X. In order to ascertain the operating state X at a prescribed time, the observer can comprise a controlled system model or a model 30 of the controlled system 32, as illustrated in FIG. 2.

The model 30 can be used to simulate or predict the effect of a down time as arises between the time of the control apparatus 22 being decoupled and the control apparatus 20 being coupled.

In the example, the model 30 has been able to be taken from a control-engineering application, that is to say the engineering data for the installation 10, as are available in the engineering system E, particularly without additional complexity. When the installation 10 is engineered to configure or design control of the process 12 by means of a respective one of the control apparatuses 20, 22, it may be that some state variables of the process 12, that is to say temperatures or other physical variables, for example, have to be ascertained indirectly because they cannot be measured directly or can be measured only with an undesirably high level of complexity and therefore need to be estimated. By way of example, this can be accomplished by using an observer method, such as a Luenberger observer 34, for example. The observer 34 shown by way of example in FIG. 2 reproduces the effects of the control output U from the control apparatus 30 on the controlled system 32, that is to say the process state of the process 12, so as thereby to ascertain internal state variables of the controlled system 32. in this case, the matrices A, B and C represented in FIG. 2 describe, in a manner that is known per se, the dynamic response of the controlled system 32 when the control output U, which changes over time, is applied. The matrix L is a correction matrix for compensating for an observation error that is ascertained at the subtraction point 36. Starting from a subtraction point 38, an integrator 40 is used to ascertain a subsequent state, that is to say a state vector that is estimated for a next observation time. The series of state vectors ascertained in this manner for multiple future times results in a state trajectory.

The model 30 is now advantageously also used to compute the response of the controlled system 32 in the changeover situation. The changeover situation is characterized in that both the input data Y and the output data U, U′ to the peripheral components 14, 16 cannot be updated for the duration of the down time T. During the down time T, the controlled system 32 is thus decoupled from the controller system R′ that is currently still active, so that it cannot be influenced by the controller system R′ and also by the controller system R that is not yet coupled.

In this regard, FIG. 3 represents how an open chain is obtained by means of the now decoupled controller system R′ and the controller system 32, because the coupling 28 has been interrupted.

FIG. 3 represents how, for this reason, the peripheral components 14, 16 have the steady control output Ustat applied.

By way of example, the peripheral outputs can maintain their last value during the changeover phase, so that the controlled system 32 has the last output vector applied during the down time T. Said output vector results in a trajectory for the state variables of the controlled system 32. Depending on the system parameters, the state variables of the controlled system 32, for example a boiler temperature, change in the undesirable case such that they reach a value that is critical for the process 12. In such a case, the failover down time of the automation system S used would be too long for the process 12 that is to be controlled. The down time T that can be expected is a characteristic variable of the high-availability control system S used, however. It is also influenced by planning and design of the automation installation 10, however, that is to say the quantities therein, the network topologies used for the peripheral insertions, and can accordingly be ascertained and adjusted for the specifically used automation system S.

In the case of the present automation system 10, the user is assisted in this by the engineering system E.

The reason is that if the down time T that can be expected is known, then it is possible to check, for example in the manner described below, whether particular state variables reach a critical value during failover. Since control failures and failovers caused thereby arise spontaneously and in unplanned fashion, the operating state X0 of the automation installation 10 is unknown, and unplannable, at the time to of failure of a control apparatus 20, 22, however. Therefore, the set of operating points, what is known as the admissible operating range in which the process 12 can reside during operation of the automation installation 10, is ascertained first of all. Exceptions in this case may be the startup and shutdown responses, for example. In addition, this set may also have safety intervals from dangerous, that is to say undesirable, operating ranges.

The set of undesirable or dangerous operating points reveals the set V of prohibited operating states, which may be defined as polytopes or polyhedra, for example. The set of admissible operating points reveals the operating range 8, which may likewise be defined as a polytope or polyhedron, for example. Physical manipulated variable restrictions Umax and Umin of the actuators among the peripheral components 14, 16 in the process 12 can likewise be ascertained, that is to say a smallest and largest valve opening, a maximum pump power, a maximum heating power, for example. Maximum absolute values can also be used as a basis for disturbance variables acting on the process 12. The model 30 for the controlled process 12 may be a linear or nonlinear model, for example the differential equation below can be used as the basis for describing the controlled system 32:

d(X(t))/dt=f(X(t), U(t), D(t)) X(t0)=X0,
ps where d()/dt represents the mathematical derivative with respect to time t, f() is a linear or nonlinear function and represents the dynamic response of the controlled system 32 in reaction to the current operating state X, the control output U and the disturbance variable D, and X0 represents an operating point at a time 0.

It is now possible to perform a reachability analysis on the basis of the model 30, the set of initial conditions to be examined, that is to say the operating point B that the controlled system 32 can adopt in line with expectations, all possible input values U in the range of the manipulated variable restrictions Umax, Umin and all possible disturbance variables D that are to be examined.

The result of the reachability analysis, for each future time t, is a set E(t) of reachable states, as arise when a control apparatus fails and thus the peripheral components 14, 16 have the steady control output Ustat applied in the manner described. In other words, the model is thus operated as follows starting from a failure time tO that is to be examined, assuming a steady control output:

d(X(t))/dt=f(X(t) Ustat, D(t)), X(t0)=X0.

The points obtained therefrom for the subsequent times t>t0 together form a state trajectory that describes the progression or the response of the controlled system 32 during the down time T.

It is now possible to ascertain the first time tv, at which the section G (tv) intersected by V is no longer empty, that is to say is therefore not an empty set. Each preceding time t<tv at which E(t) intersected by V forms an empty set determines an admissible time horizon tvo for safe operation. This time horizon tvo can also be shortened still further by a buffer time for safety reasons. The time tv is the longest tolerable changeover time for failover.

In the engineering system E, said time can be used for selecting the components for the automation installation 10. If, during the actual engineering, that is to say the design and configuration of the automation installation 10, it is known, as a result of knowledge of the control algorithms of the control systems R, R′, that the limits Umax, Umin of the manipulated variables are not fully utilized, then it is also possible to stipulate a range of the control outputs U, U′ that is narrowed down accordingly. This likewise increases the acceptable latency for changeover.

It is advantageous if the engineering system E indicates these adjustment options to the user so that he does not select an excessively expensive alternative installation component at an early stage. If the down time t continues to be too long, then it is likewise possible to shorten the down time t in the event of a failover by changing the installation topology. The user can check this likewise using the engineering system E. As part of an iterative procedure, the user can thereby tailor the installation topology to the requirements of the process 12 that is to be automated.

By way of example, the reachability analysis 42 can be performed by an analysis device of the engineering system E, for example a program module of the engineering system E and, in this context, a process model 44 of the process 12 to be operated and also a topology model 46 of the automation installation 10, as the user has currently stipulated. From the process model 44, which describes the physical actions in the process 12, and the topology model 46, it is possible for the model 30 of the controlled system 32 to be ascertained in a manner that is known per se according to the principles of control engineering. Additionally, the topology model 46 reveals a value for the down time T.

The reachability analysis can ascertain the state trajectory for different operating points of the operating range B in a step S10 and, in a step S12, can check a safety criterion 48 for each state trajectory, that is to say whether the respective state trajectory reaches the set V, for example. If this is the case, symbolized by a plus sign (+) in FIG. 4, then a safety measure is initiated in a step 48, such as the described display of the critical operating point by the engineering system E, for example. Otherwise, that is to say if all state trajectories signal a safe changeover action (symbolized by a minus sign (−) in FIG. 4), the failure tolerance of the topology model 46, that is to say of the automation installation 10 in its present design state, can be signaled in a step S16.

Hence, the exemplary embodiment as a whole describes a method for model-based determination of the effects of a failover in a high-availability automation system on a process that is to be controlled.

### LIST OF REFERENCE SYMBOLS

10 Automation installation

Process

14, 16 Peripheral component

18 Communication network

20, 22 Control apparatus

24 Synchronization connection

26 Control connection

28 Decoupled control connection

30 Controlled system model

32 Controlled system

34 Observer

36, 38 Subtraction point

40 Integrator

42 Reachability analysis

44 Process model

46 Topology model

48 Safety criterion

E Engineering system

U, U′ Control output

R, R′ Control system

W Nominal value preset

T Down time

S10-S16 Method step

Ustat Steady control output

1.-15. (canceled)

16. A method for monitoring a failure tolerance for an automation installation, comprising:
providing a controlled system and at least two control apparatuses, said at least two control apparatus alternately controlling the controlled system during a normal operation by outputting control outputs, said automation installation operating a process via the control system;
prompting a changeover between the at least two apparatuses at a failure;
continuously operating the controlled system during the changeover in a controller-less operation for a down time;
ascertaining a possible operating point for the controlled system during the normal operation;
simulating a controller-less operation for each operating point for a duration of the down time to thereby ascertain a state trajectory starting out from the operating point for the controlled system;
checking whether the state trajectory fails to meet a predetermined safety criterion; and if affirmative initiating a predetermined protective measure to avoid the at least operating point.

17. The method of claim 16, wherein the controller-less operation is simulated by a simulation starting out from the at least one operating point using a model of the controlled system by temporally and successively computing the at least one operating point and the at least one computed operating point is combined to produce the state trajectory.

18. The method of claim 16, wherein the safety criterion includes whether the state trajectory comprises the at least one operating point that lies outside a predetermined admissible operating range, and/or whether a dynamic transition between two operating points of the state trajectory is greater than a predetermined maximum admissible dynamic range.

19. The method of claim 16, wherein a protective measure comprises outputting a warning to a user of the automation installation.

20. The method of claim 19, wherein during the controller-less operation a constant control output is transmitted to the controlled system and the protective measure comprising the constant control output is ascertained that reveals for a respective operating point a safe trajectory for continued operation of the controlled system and the ascertained constant control output is assigned to the at least one operating point.

21. The method of claim 20, wherein the respective operating point is assigned a safety control output that is output at the operating point in an event of the changeover and interrupts an operation of the controlled system.

22. The method of claim 19, wherein the protective measure comprises engineering data from the automation installation being taken as a basis for ascertaining an installation component causing the greatest proportion of the down time, and/or adopting an inadmissible operating point in line with the state trajectory.

23. The method of claim 19, wherein the control apparatuses use a synchronization connection to interchange synchronization data for aligning controller states and the protective measure comprises a rate of the synchronization connection being increased.

24. The method of claim 20, wherein the protective measure comprises the respective operating point being excluded from the normal operation and controller parameters of the control apparatuses being adjusted.

25. The method of claim 17, wherein the simulation includes an assumption about a maximum absolute value of a disturbance variable acting in the controlled system for the simulation and the protective measure includes the maximum absolute value being decreased and a new simulation being performed and the disturbance variable being indicated if the safety criterion is met for the new simulation.

26. The method of claim 19, wherein a new monitoring of the failure tolerance is iteratively performed after the protective measure is performed.

27. The method of claim 16, wherein the at least one operating point is ascertained by ascertaining an intended operating range on a basis of a configuration of the automation installation.

28. The method of claim 27, wherein the at least one possible operating point is ascertained by taking into consideration only extreme values for manipulated variable restrictions of installation components.

29. An engineering system for designing and/or configuring an automation installation having at least two control apparatuses for controlling a controlled system, said engineering system comprising an analysis device configured to take a present topology model of the automation installation and a process model of a process to be performed via the automation installation as a basis for ascertaining the resultant controlled system and a down time caused by a changeover between the control apparatuses, said analysis device configured to:
provide a controlled system and at least two control apparatuses, said at least two control apparatus alternately controlling the controlled system during a normal operation by outputting control outputs, said automation installation operating a process via the control system;
prompt a changeover between the at least two apparatuses at a failure;
continuously operate the controlled system during the changeover in a controller-less operation for a down time;
ascertain a possible operating point for the controlled system during the normal operation;
simulate a controller-less operation for each operating point for a duration of the down time to thereby ascertain a state trajectory starting out from the operating point for the controlled system;
check whether the state trajectory fails to meet a predetermined safety criterion; and if affirmative
initiate a predetermined protective measure to avoid the at least operating point.

30. An automation installation having a controlled system for operating a process and having at least two control apparatuses for failsafe and alternate control of the controlled system, said automation installation being configured to monitor a failure tolerance during operation by:
providing a controlled system and at least two control apparatuses, said at least two control apparatus alternately controlling the controlled system during a normal operation by outputting control outputs, said automation installation operating a process via the control system;
prompting a changeover between the at least two apparatuses at a failure;
continuously operating the controlled system during the changeover in a controller-less operation for a down time;
ascertaining a possible operating point for the controlled system during the normal operation;
simulating a controller-less operation for each operating point for a duration of the down time to thereby ascertain a state trajectory starting out from the operating point for the controlled system;
checking whether the state trajectory fails to meet a predetermined safety criterion; and if affirmative
initiating a predetermined protective measure to avoid the at least operating point.
